(19) United States
(12) Patent Application Publication
(10) Pub. No.: US 2007/0095668 A1
(43) Pub. Date: May 3, 2007

(54) LIQUID NITROGEN LEVEL CONTROL SYSTEM

(76) Inventors: Phillip Pendleton, Modbury (AU); Alexander Badalyan, Paradise (AU)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/555,275

(22) Filed: Oct. 31, 2006

(30) Foreign Application Priority Data
Oct. 31, 2005 (AU) 2005906007

(51) Int. Cl. B01D 61/42

(52) U.S. Cl. 204/516

(57) ABSTRACT

A liquid container arrangement for controlling the level of liquid in a container is disclosed. The liquid container arrangement includes a first compartment open to atmosphere and to which evaporative loss of liquid occurs and a second compartment that is closed to atmosphere and in liquid communication with the first compartment. The liquid container arrangement also includes adjustment means for adjusting the level of the liquid in the second compartment to vary the level of the liquid in the first compartment.

### FIELD OF THE INVENTION

The present invention relates to controlling the level of fluid in a container. In particular, it relates to maintaining the level of cryogenic liquid in a container.

### BACKGROUND OF THE INVENTION

Cryogenic liquids have a low boiling point and rapidly evaporate in room temperature air, therefore, the level of cryogenic liquid in a container quickly falls over a period of time. Researchers who work in the area of gas adsorption by solid materials appreciate that any variation in the level of cryogenic liquid around a sample tube can significantly affect the stability of the equilibrium pressure and therefore the reliance that can be placed on any data associated with the experiment conducted in the sample tube.

Arrangements are known to control the level of cryogenic liquid in a container including a sensor is employed to detect the level of cryogenic liquid in the vicinity of the sample tube located with in the container. When the level of cryogenic liquid falls below a pre-set level, that condition is detected and a top up of the cryogenic liquid is supplied from an external reservoir of cryogenic liquid.

While generally effective in maintaining the cryogenic liquid level in the vicinity of the sample tube, this arrangement suffers from a number of disadvantages. In particular, this arrangement merely tops up the falling cryogenic liquid levels and uses a valuable cryogenic liquid resource without trying to minimise the cause of the loss. In addition, it has been found that the temperature fluctuations that occur in the volume about the sample are not always within acceptable or useable limits.

It is an object of the present invention to reduce or eliminate some or all of the disadvantages of the cryogenic liquid level control arrangement described above.

The invention will be generally discussed in relation to cryogenic liquids but it is not so restricted and may be applied to other liquid container systems where liquid level control is desirable.

### SUMMARY OF THE INVENTION

The present invention accordingly provides a liquid container arrangement including:
a first compartment open to atmosphere and to which evaporative loss of liquid occurs;
a second compartment closed to atmosphere and in liquid communication with the first compartment, and in use having liquid in each compartment; and
adjustment means for adjusting the level of the liquid in the second compartment to vary the level of the liquid in the first compartment.

In another alternative form, the present invention accordingly provides a liquid container including:
a first compartment open to atmosphere and to which evaporative loss of liquid occurs;
a second compartment closed to atmosphere and in liquid communication with the first compartment, and in use having liquid in each compartment;
a sensor which detects the level of the liquid in the first compartment and output a level indicating signal; and
adjustment means for adjusting the level of the liquid in the second compartment in response to the output level indicating signal of the sensor to vary the level of the liquid in the first compartment.

Preferably, adjustment of the level of liquid in the first compartment is effected by adjusting the pressure above the liquid in the second compartment.

Further preferably, adjustment of the level of liquid in the first compartment is effected by adjusting gas pressure above the liquid in the second compartment.

In a preferred embodiment the gas providing the gas pressure is gas boiled off from the liquid in at least a portion of the second compartment.

Preferably, the adjustment means for adjusting the level of liquid in the second compartment includes a valve which while closed traps gas above the liquid in the second compartment to provide a pressure above the liquid in the second compartment such that the liquid in the second compartment falls and consequently the liquid level in the first compartment rises.

Further preferably, the means for adjusting the level of liquid in the second compartment includes a valve which while open relieves gas pressure above the liquid in the second compartment such that the liquid in the second compartment rises and consequently the liquid level in the first compartment falls.

Further preferably, the valve for relieving gas pressure above the liquid in the second compartment is a proportioning valve.

Preferably, the sensor is an N-type thermocouple. Further the N-type thermocouple is at least partially covered in a stainless steel sheath. The level of the liquid in the first compartment is detected by the temperature measured by the thermocouple which depends upon the depth of immersion of the thermocouple in the liquid.

Preferably said liquid is a cryogenic liquid.

Further preferably, said cryogenic liquid is liquid nitrogen.

Preferably the container is an insulated Dewar vessel; the first and second compartments may be separate containers joined by a tube, or a single container with the first compartment within the second compartment that are in fluid communication.

Further preferably the container has external walls which are hollow and are evacuated to minimise temperature variation due to varying ambient conditions.

The present invention also provides a method of controlling the level of liquid in a first compartment of a liquid container arrangement including, a first compartment open to atmosphere and to which evaporative loss of liquid occurs; a second compartment closed to atmosphere and in liquid communication with the first compartment, and in use having liquid in each compartment; the method including the step of:
adjusting the level of the liquid in a second compartment of the container y the admission or release of gas into the second compartment, thereby varying the level of the liquid in the first compartment.

Preferably, the method also includes:
sensing the level of liquid in the first compartment, and
adjusting the level of the liquid in the second compartment in response to the level sensed in the first compartment.

The method is preferably performed by apparatus such as a computer device executing specifically designed software, or by other purpose-built hardware. For instance, an integrated circuit may be designed specifically to perform the above method in conjunction with other devices.

A detailed description of one or more preferred embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF THE DRAWINGS

An illustrative embodiment of the present invention will be discussed with reference to the accompanying drawings wherein:

FIG. 1 is a cross-sectional side view of a container according to a preferred embodiment;

FIG. 2 is a top view of the container according to a preferred embodiment;

FIG. 3 is a side cross sectional view of the container where the liquid nitrogen level in the first compartment is rising;

FIG. 4 is a side cross sectional view of the container where the liquid nitrogen level in the first compartment is falling;

FIG. 5 is a side cross-sectional view of a container according to another embodiment; and

FIG. 6 is a side cross-sectional view of a container.

### DESCRIPTION OF PREFERRED EMBODIMENT

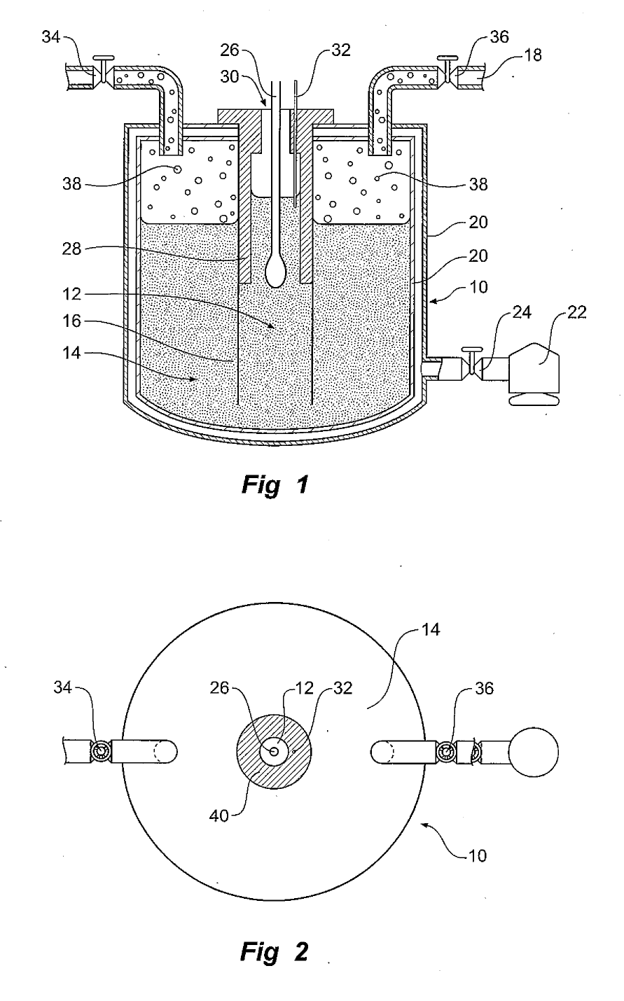

FIG. 1 depicts a container for cryogenic liquid with external walls and a first compartment that is capable of accepting a sample. Preferably the container is insulated and can be made from stainless steel. The first compartment has in place a temperature sensor, preferably an N-type thermocouple that monitors any variation of the level of liquid nitrogen in the first compartment. The external walls of the container also form a second compartment in liquid communication with the first compartment such that the liquid nitrogen in the container occupies a portion of both the compartments. The second compartment is enclosed such that the surface of the liquid nitrogen that occupies a portion of this compartment is not exposed to the atmosphere. Valves are fitted to the container and are located in the external wall adjacent the volume above the liquid nitrogen contained in the second compartment. A valve responds to information from a thermocouple regarding the level of liquid nitrogen located in the first compartment. The valve is used to adjust the pressure above the liquid nitrogen in the second compartment to change the level of the liquid nitrogen in the first compartment.

The present arrangement substantially reduces the rate of use of the liquid nitrogen compared to prior arrangements. Further, the range of temperature fluctuation in the open portion of the reservoir is also substantially less than prior arrangements.

Preliminary gas adsorption experiments have shown that the present system maintains levels of liquid nitrogen within ±0.5 mm of a preset level, with a consumption of liquid nitrogen of about 6 litres per 10 hours.

FIG. 1 shows a side cross-sectional view of the liquid nitrogen container arrangement 10 having in this embodiment a first compartment 12 and a second compartment 14. It should be noted that the term compartment is used in its broadest form and a compartment may be defined by one or more complete or partial walls in the same container or may be defined by walls forming two containers linked on some way. By way of example, liquid nitrogen 16 is introduced into the container through a filler point 18. The wall/s of the container 20 are, in this embodiment, of the double skin type that can be evacuated using a vacuum pump 22 connected to the valve 24. The latter configuration and evacuation step is merely preferable.

FIG. 1 also shows that the first and second compartments are in liquid communication such that the liquid nitrogen 16 occupies a portion of both the first 12 and second compartments 14. The liquid nitrogen and the configuration of the compartments are such that there is not transference of gasses between the compartments during use of the container for housing a sample.

The first compartment is shaped and sized to accept the insertion and positioning of a sample container or tube 26. It is optional that the first compartment can be further insulated during an experiment by providing a removable insulating sleeve 28 with an opening 30 large enough to accept the sample 26. In this embodiment a level sensor is used to determine the level of liquid in the first compartment. The sensor, by way of example only since other level detecting and measuring sensors are useable and will be known to those skilled in the art, is an N-type thermocouple 32 which is located within the first compartment to detect the level of liquid nitrogen in that compartment and which provides an output signal representative of the level. The second compartment includes adjustment means, that include by way of example only in the embodiment disclosed, valves 34 and 36 located above the level of liquid nitrogen in the second compartment. When the valves are closed, gas pressure 38 is retained and thus trapped within the internal volume of the second compartment which is isolated from the external environment.

FIG. 2 shows a top view of the container. In this embodiment, an open to atmosphere portion of the first compartment 12 is located central to the container 10. The top portions of the sample 26, the N-type thermocouple 32 and the insulating sleeve 40 are also shown.

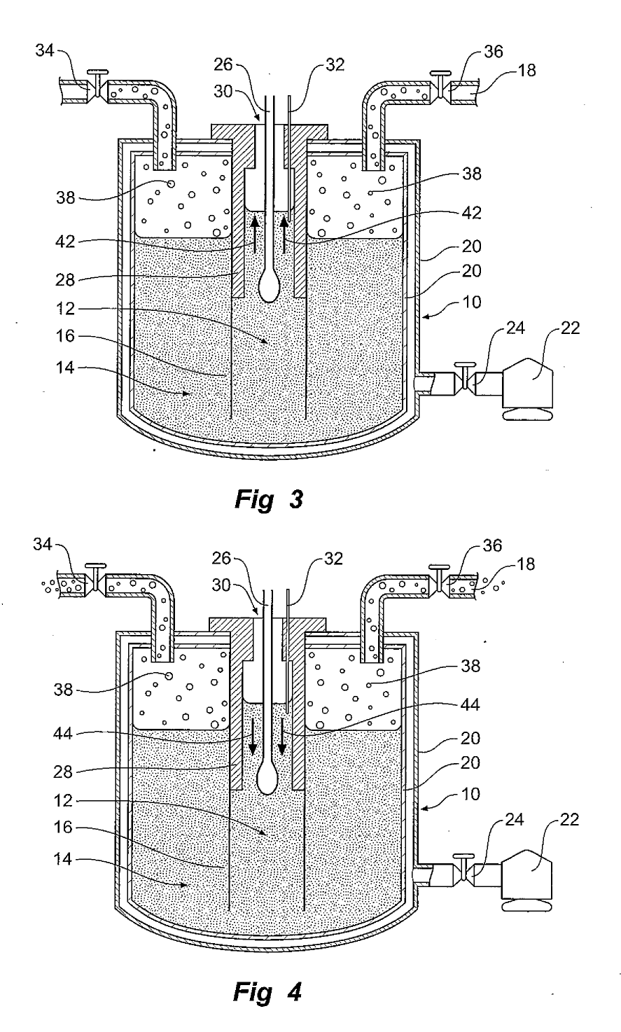

FIG. 3 illustrates the effect of a build up of gas pressure 38 in the second compartment 14. The arrows 42 in the first compartment denote the upward direction of the liquid nitrogen level in the first compartment 12 as the gas pressure in the second compartment increases. This build up of gas pressure is likely to occur for the duration of the experiment but the rise of the liquid nitrogen in the first compartment will be moderated by losses caused by evaporation of the liquid nitrogen through the opening at the top of the first compartment.

FIG. 4 illustrates the effect of the relief/release of gas from the second compartment 14 by opening the valve 34. The arrows 44 in the first compartment denote the downward direction of the liquid nitrogen level in the first compartment 12 when a portion of the gas in the second compartment is released through valve 34 or in some cases valve 36. This particular cause and effect can occur if the liquid nitrogen rises above the pre-set level on the thermocouple thus affecting the output signal and having a predetermined level or characteristic that is detectable and thus useable to control the adjustment means. The sensor can also be used to detect liquid level during the original filling operation to help prevent overfilling the container or the level in the first compartment needs to be adjusted without reliance on evaporation of the liquid.

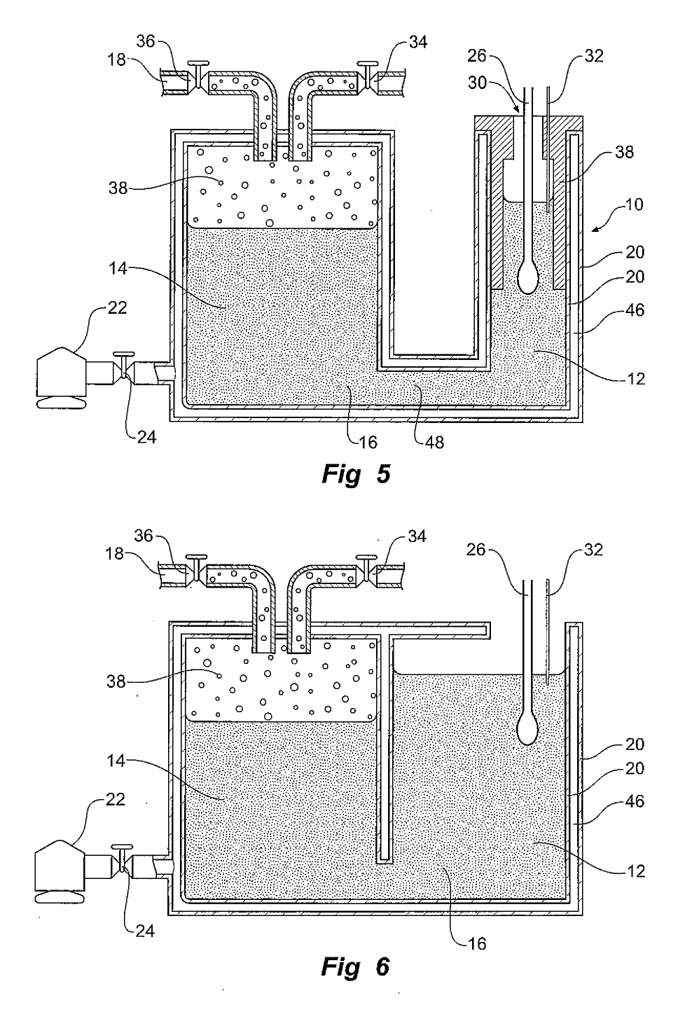

FIG. 5 shows a side cross-sectional view of a container arrangement 10 according to another embodiment of the present invention, consisting of a first compartment 12 and a second compartment 14 with a tube 48 extending between them providing liquid communication between each compartment. In this embodiment the liquid within the container arrangement is liquid nitrogen 16 that has been introduced into the container 10 through the filler point 18 and valve 36. The walls of the container 20 and tube 48 are hollow 46 and can be evacuated using a vacuum pump 22 connected to valve 24 to provide insulation to the liquid nitrogen within the container. The latter configuration and evacuation step is preferable.

FIG. 5 also shows that the first and second compartments are in liquid communication such that the liquid nitrogen 16 occupies a portion of both the first and second compartments. The first compartment 12 is open to atmosphere and is shown containing a sample container or tube 26 that depends into the liquid nitrogen. It is optional that the first compartment can be insulated during an experiment by providing a removable insulating cover 40 with an opening 30 large enough to accept the sample 26. The volume above the liquid nitrogen in the second compartment is sealed to the external environment, which is it is closed to atmosphere.

A sensor that detects the level of liquid in the first compartment and outputs a level indicating signal is in this embodiment, an N-type thermocouple 32. The second compartment 14 includes an adjustment means that in this embodiment is a proportioning relief valve 34 located above the level of liquid nitrogen in the second compartment. When the valves are closed nitrogen gas pressure 38 is trapped in the second compartment.

FIG. 6 shows a side cross-sectional view of the liquid nitrogen container 10 according to another embodiment of the present invention, consisting of a first compartment 12 open to atmosphere and a second compartment 14 that is closed to atmosphere, also showing that the first and second compartments are in liquid communication with each other.

Liquid nitrogen 16 is introduced into the container through the filler point 18 and valve 36. FIG. 6 shows that the first and second compartments are in liquid communication such that the liquid nitrogen 16 occupies a portion of both the first and second compartments. The first compartment 12 is capable of accepting a sample container or tube 26. A sensor that detects the level of liquid in the first compartment and outputs a level indicating signal is in this embodiment, an N-type thermocouple 32 is located in the first compartment to detect the level of liquid nitrogen. The second compartment 14 includes a proportioning relief valve 34 above the level of liquid nitrogen. When the valve 34 is closed nitrogen gas pressure 38 is trapped in the second compartment.

A thermally sensitive device that has a sensing element with small dimensions is located in the first compartment where the level of the liquid nitrogen is to be kept constant. In the preferred embodiment the thermally sensitive device is an N-type thermocouple. For structural protection of its sensitive element the thermocouple is placed inside a stainless steel sheath. This sensor arrangement is advantageously used because the temperature value produced by the thermocouple corresponds to a predetermined immersion depth, L, in the liquid nitrogen, after calibration. The level of liquid nitrogen along the length of the thermocouple sheath has a correlation to the temperature in accord to the values in Table 1.

TABLE 1
The temperature variation as the liquid nitrogen level varies.

| | Temp ° C. | | | | | | |
|---|---|---|---|---|---|---|---|
| | −165.0 | −170.0 | −175.0 | −180.0 | −185.0 | −190.0 | −195.0 |
| L | 0 | 0.2 | 0.5 | 0.8 | 1.3 | 2.0 | 3.0 |
| mm | | | | | | | |

The variation of liquid nitrogen level from 1.3 mm to 3.0 mm, from the bottom of the thermocouple sheath, gives a variation in temperature readings from −185.0° C. to −195.0° C. The thermocouple can therefore be used to monitor any variation of the liquid nitrogen level in the first compartment within the range of 1.3 mm to 3.0 mm from the bottom of the thermocouple sheath while knowing that the temperature varies between −185.0° C. and −195.0° C. As a precaution, thermocouples from the same manufacturer may differ in terms of the position of the hot junction inside the sheath. Therefore it is recommended that calibration measurements be performed, similar to those shown in Table 1, for each new thermocouple prior to use so as to improve the precision of level control.

A set-point of −190.0° C. is chosen so that the level of liquid nitrogen is maintained within at least 2 mm from the bottom of the thermocouple sheath. One reason for setting that set-point is that smooth changes in temperature readings occur when the liquid nitrogen level is set at 2 mm above the lower end of the thermocouple sheath. When the current value of temperature as measured by the thermocouple is greater than the set-point i.e. the liquid nitrogen level is below the desired level.

The sensor provides or can be determined to have provided an output signal representative of the level of the liquid and a personal computer or other purpose-built controller operating in the proportional P or proportional-plus-integral PI or proportional-plus-integral-plus-derivative PID mode supplies voltage from 0-10 V DC to a proportioning relief valve.

The proportioning valve adjusts between fully open to fully closed depending upon the level of the supplied voltage. When the valve is almost closed gas pressure builds up in the enclosed second compartment and the level of liquid nitrogen in the first compartment rises. The temperature measured by the thermocouple will thus decrease accordingly. When the temperature reading of the thermocouple reaches the set-point, the proportioning relief valve is opened and some pressure above the level of liquid nitrogen in the second compartment is relieved.

This arrangement maintains the level of liquid nitrogen located about the sample to within ±0.5 mm of a pre-set set point level in the first compartment without having to replenish the container with liquid nitrogen.

Of course, the degree of adjustment required will vary depending on factors such as the type of liquid and the relative sizes of the first and second compartments.

It is also preferable, for precautionary reasons, to ensure that there is always minimum liquid nitrogen level in the container, thus a yet further level detection sensor can be used. That sensor arrangement can be the same as prior arrangements. The sensor is located at a predetermined minimum liquid nitrogen level location in the container.

Although a preferred embodiment of the apparatus of the present invention has been described in the foregoing detailed description, it will be understood that the invention is not limited to the embodiment disclosed, but is capable of numerous rearrangements, modifications and substitutions without departing from the scope of the invention. Modifications and variations such as would be apparent to a skilled addressee are deemed within the scope of the present invention.

For example the invention is not limited to the liquid used in the container being liquid nitrogen but is useful for any liquid with a boiling point that is sufficiently low so as to permit a pressure build up within the enclosed second compartment and which is lost to atmosphere from the first compartment.

The invention is also not limited to the use of the naturally accumulated gas pressure above the liquid. Other means of pressure control may include, for example, directly applied pressure via mechanical arrangements or additional pressure could be fed into or removed from the container using the same gas or other suitable gas.

The invention is not limited to the construction of the container revealed in the preferred embodiments. The compartments of the container could be arranged in any way such that the pressure within one or more compartments affects the liquid nitrogen level in the compartment that accepts the sample.

Naturally, the accuracy of level control achieved by the invention may be affected by some of these variations. For example, if the volume of the second compartment is larger, this may provide for greater accuracy. However, it may also result in greater use of the liquid nitrogen or other liquid.

The invention is not limited by choice of sensor or type of valve, nor in the way the apparatus interact with each other.

The reference to any prior art in this specification is not, and should not be taken as, an acknowledgment or any form of suggestion that such prior art forms part of the common general knowledge.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

The claims defining the invention are as follows:

1. A liquid container arrangement including:
a first compartment open to atmosphere and to which evaporative loss of liquid occurs;
a second compartment closed to atmosphere and in liquid communication with the first compartment, and in use having liquid in each compartment; and
adjustment means for adjusting the level of the liquid in the second compartment to vary the level of the liquid in the first compartment.

2. A liquid container arrangement according to claim 1 further including:
a sensor which detects the level of the liquid in the first compartment and output a level indicating signal; wherein the adjustment means for adjusts the level of the liquid in the second compartment in response to the output level indicating signal of the sensor to vary the level of the liquid in the first compartment.

3. A liquid container arrangement according to claim 1 wherein adjustment of the level of liquid in the first compartment is effected by adjusting the pressure above the liquid in the second compartment.

4. A liquid container arrangement according to claim 1 wherein adjustment of the level of liquid in the first compartment is effected by adjusting gas pressure above the liquid in the second compartment.

5. A liquid container arrangement according to claim 4 wherein the gas providing the gas pressure is gas boiled off from the liquid in at least a portion of the second compartment.

6. A liquid container arrangement according to claim 1 wherein the adjustment means for adjusting the level of liquid in the second compartment includes a valve which while closed traps gas above the liquid in the second compartment to provide a pressure above the liquid in the second compartment such that the liquid in the second compartment falls and consequently the liquid level in the first compartment rises.

7. A liquid container arrangement according to claim 1 wherein the means for adjusting the level of liquid in the second compartment includes a valve which while open relieves gas pressure above the liquid in the second compartment such that the liquid in the second compartment rises and consequently the liquid level in the first compartment falls.

8. A liquid container arrangement according to claims 6 wherein the valve for relieving gas pressure above the liquid in the second compartment is a proportioning valve.

9. A liquid container arrangement according to claims 7 wherein the valve for relieving gas pressure above the liquid in the second compartment is a proportioning valve.

10. A liquid container arrangement according to claim 2 wherein the sensor is an N-type thermocouple.

11. A liquid container arrangement according to claims 10 wherein the N-type thermocouple is at least partially covered in a stainless steel sheath.

12. A liquid container arrangement according to claims 10 wherein the level of the liquid in the first compartment is determined by the temperature measured by the thermocouple which depends upon the depth of immersion of the thermocouple in the liquid.

13. A liquid container arrangement according to claim 1 wherein the liquid is a cryogenic liquid.

14. A liquid container arrangement according to claim 13 wherein said cryogenic liquid is liquid nitrogen.

15. A liquid container arrangement according to claim 1 wherein the container is an insulated Dewar vessel.

16. A liquid container arrangement according to claim 1 wherein the first and second compartments are separate containers joined by a tube.

17. A liquid container arrangement according to claim 1 wherein the container is a single container having a first compartment within a second compartment with the first compartment in fluid communication with the second compartment.

18. A liquid container arrangement according to claim 1 wherein the container has external walls which are hollow and are evacuated.

19. A method of controlling the level of liquid in a first compartment of a liquid container arrangement including, a first compartment open to atmosphere and to which evaporative loss of liquid occurs; a second compartment closed to atmosphere and in liquid communication with the first compartment, and in use having liquid in each compartment; the method including the step of:
adjusting the level of the liquid in a second compartment of the container y the admission or release of gas into the second compartment, thereby varying the level of the liquid in the first compartment.

20. A liquid container arrangement according to claim 19 wherein also includes:
sensing the level of liquid in the first compartment, and
adjusting the level of the liquid in the second compartment in response to the level sensed in the first compartment.
